(19) United States
(12) Patent Application Publication
(10) Pub. No.: US 2002/0050538 A1
(43) Pub. Date: May 2, 2002

(54) Rotary blade shredding apparatus with stationary bars in the form of a sinusoidal or broken line, acting as counterblade and grid

(76) Inventor: Rota Fabio, Milano (IT)

Correspondence Address: SHERIDAN ROSS PC, 1560 BROADWAY, SUITE 1200, DENVER, CO, 80202

(21) Appl. No.: 09/964,183

(22) Filed: Sep. 25, 2001

(30) Foreign Application Priority Data
Oct. 26, 2000 (EP) 00830709.2

(51) Int. Cl. B02C 18/16

(52) U.S. Cl. 241/88.4; 241/236

(57) ABSTRACT

A rotary blade shredding apparatus comprising a plurality of shredder rollers (14, 15, 16) with parallel axes, each roller comprising a rotationally driven shaft and a plurality of rotating blades spaced axially therealong, and a cut-cooperating screening member (20), the blades of adjacent rollers being axially intercalated, characterized in that the cut-cooperating screening member comprises a plurality of bars (22) having a shape among the following: a broken line (22a), a wavy line (22b), so as to have bar portions protruding from one side and the other of a theoretical median line (m) of the bar.

### DESCRIPTION

The invention refers to the field of shredding or comminuting apparatuses with rotary blades, as are generally used for comminution of materials such as wood, paper, waste, etc.

Shredding or chopping apparatuses of a type currently on the market comprise rotating shredding or comminuting rollers, with parallel axes, collaborating with a stationary grid disposed below. In particular each shredding roller comprises a shaft which bears a plurality of toothed disc blades. The blades are in longitudinally offset positions on adjacent shafts, so that the peripheries thereof define intersecting cylinders. The grids are shaped like an arc of a circle, co-axially to the rollers, and are disposed just outside same.

The material is cut between the blades of adjacent rollers, falls onto and through the grid or is pushed through the grid by the action of the blades. The material that does not pass through the grid is swept up by the blades, so that it is again subjected to comminution.

The grids are generally made of perforated sheet metal.

The same applicant, in an earlier European patent application No. 00107738.7, not yet published, describes a grid formed by toothed bars acting as a counterblade.

The apparatus described in the preceding application has made it possible to achieve considerable advantages with respect to traditional apparatuses. However, the toothed bars described (T-shaped in section, with teeth having a sharpened edge on the flange of the T) was relatively costly to produce, in that each bar required cutting and then sharpening. Moreover, it has been seen from experimental trials that it was often necessary to provide further reinforcements, given the high stresses with a radial component to which the grid was subjected.

The object of the present invention is thus to simplify the construction of a shredding apparatus with rotary blades and a grid, whilst maintaining the advantages of the grid with toothed bars. A further object is to reduce production costs.

These objects have been achieved with an apparatus as stated in claim 1 and with a cut-cooperating member as stated in claim 7.

The new apparatus achieves the aims stated above, that is to say it is easier to construct and has reduced production costs. Moreover, the bars are particularly strong and do not require reinforcements. Furthermore, the cut-cooperating screening member has a more favourable ratio of holes or hollows to solid parts (hollow/solid ratio) than in the case of a traditional grid. As is known, the greater the hollow/solid ratio of the grid, the better the performance of the shredding apparatus.

Exemplary unrestrictive embodiments of the invention will be described below with reference to the attached drawings, in which:

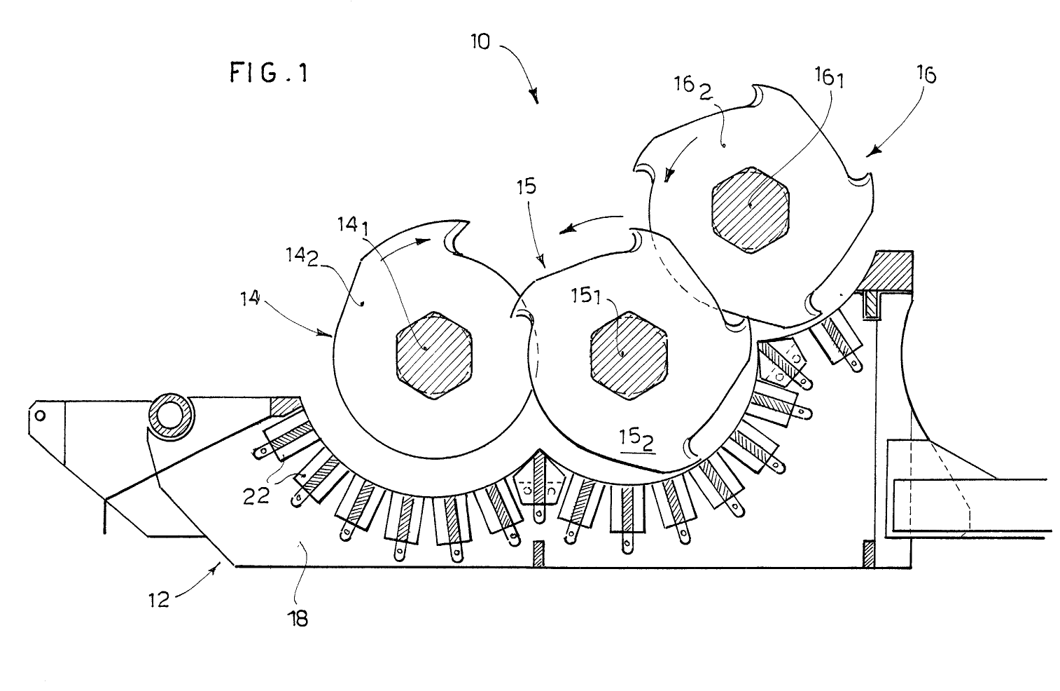

FIG. 1 is a vertical sectional view through an apparatus of the invention, taken in a plane at right angles to the axis of the shredder rollers;

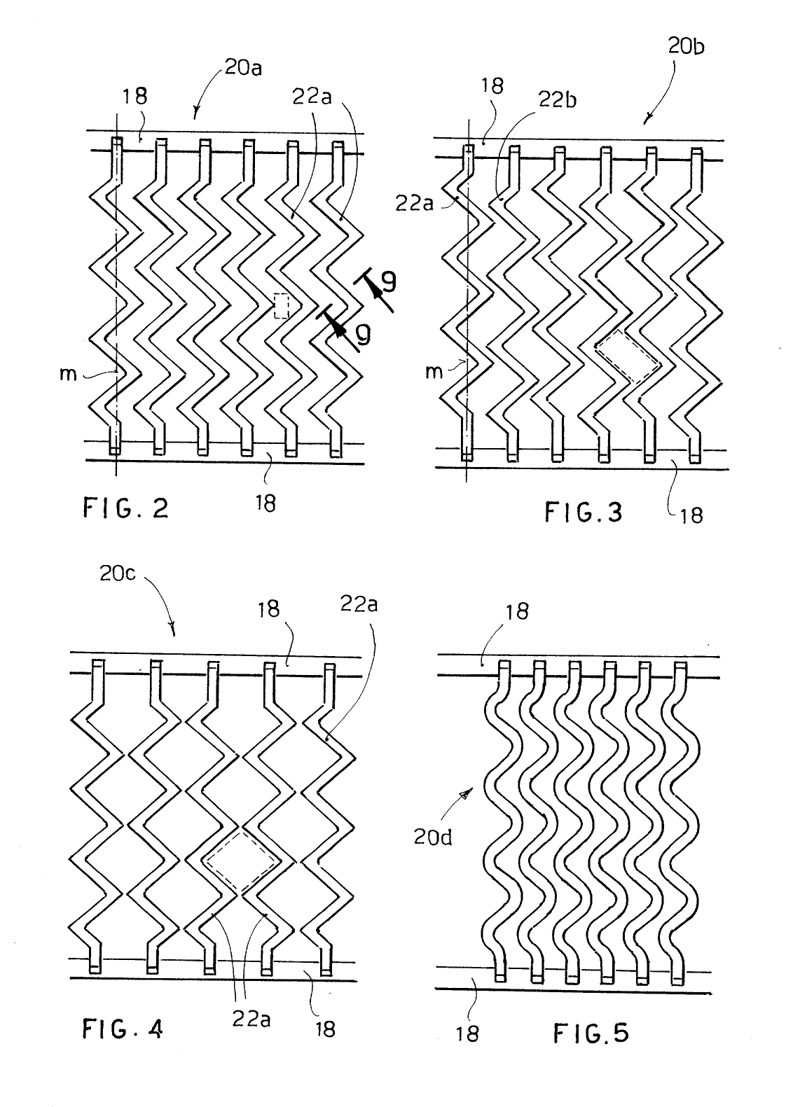

FIGS. 2 to 7 are broken off development views of embodiments of cut-cooperating screening members of the apparatus of the invention;

FIG. 8 is a broken-away perspective view of a bar of the member shown in FIG. 2;

FIG. 9 is a vertical sectional view taken along 9-9 in FIG. 2.

In the figures, reference numeral 10 denotes a shredder apparatus.

It comprises a casing 12, of which only a lower part can be seen in FIG. 1. An upper part (not shown) of the frame bears three comminuting or shredding rollers respectively with references 14, 15 and 16 (the shredder rollers could be two or more than three in number without departing from the scope of the invention). Each shredder roller comprises a respective rotating shaft and the rotating shafts are referenced 14₁, 15₁, 16₁. Each shaft is rotationally driven by known means, not shown, and rotates around a respective axis a₁₄, a₁₅, a₁₆, the three axes being parallel to one another.

The shaft 14₁ carries rotating blades 14₂ axially spaced along said shaft. The shaft 15₁ carries rotating blades 15₂ axially spaced along said shaft and axially intercalated with the blades of the shaft 14. The shaft 16, carries rotating blades 16₂ intercalated axially with the blades of the roller 15. The two rollers 14, 15 are counter-rotating. The two rollers 15₁, 16₁ turn in the same direction. The directions of rotation of the rollers are indicated by the arrows in the figure and are only indicative, in that they can be different for other embodiments.

The lower part of the frame has end walls 18 on which a cut-cooperating and screening member, referenced 20 as a whole, is mounted. The member 20 will henceforth also be called “grid” for simplicity's sake, even if it does not correspond to the traditional definition of a grid.

The member 20 is composed of a plurality of bars 22 extending transversally to the direction of rotation of the periphery of the blades; in general the overall extension of the bars is substantially parallel to the axes of the rollers.

Each bar has a substantially rectangular cross section, as can be seen in FIG. 9, preferably with a largest side of the rectangle disposed radially with respect to the axis of the roller, and in a plan view has a broken line, sinusoidal or curved line configuration, so as to present, on one side and the other of a theoretical median line m of the bar (drawn with a dash-dot line), protruding parts with inclined walls that can be considered like a toothing. The broken line or curve shape is preferably repeated regularly for the whole length of the bar.

The ends of the bars are shaped and fixed in any way desired to the part 18.

The upper surface 23 of the bar is ground. The edges 24, 25 act as cutting teeth edges.

The bars can be disposed according to different configurations, of which only a few currently preferred ones are shown in FIGS. 2 to 7.

In a grid 20a in FIG. 2 bars 22a have a broken line shape as seen in plan view and are disposed with the tips of the corresponding teeth aligned along the extension of the grid.

In a grid 20b in FIG. 3 bars 22a like those in FIG. 5 are alternated with bars 22b having substantially the same broken-line shape but with the tips offset in position with respect to the bars 22a.

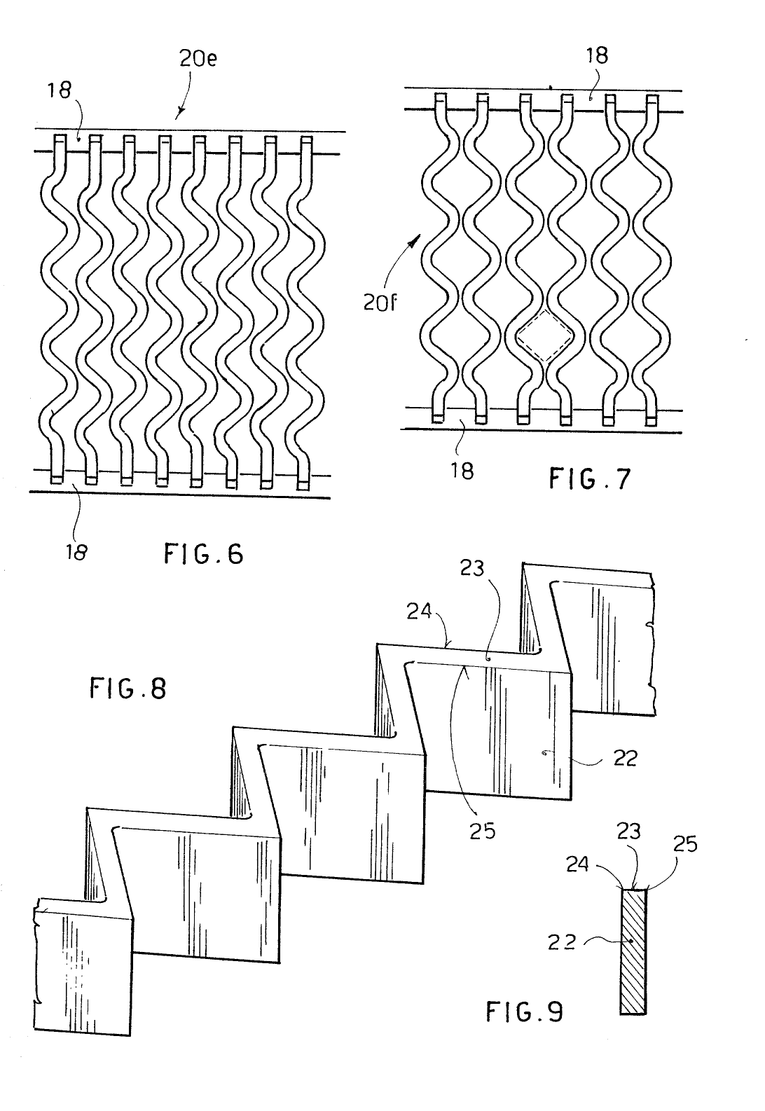

In the grid 20c in FIG. 4 the bars 22a are mounted with the teeth opposed. Grids 20d in FIG. 5, 20e in FIG. 6, and 20f in FIG. 7 have a wave-like shape, possibly sinusoidal, with rounded tooth portions.

In the grid 20d the bars are disposed in a parallel fashion, in the grid 20e the bars have the tooth portions offset in the longitudinal direction of the bars, in the grid 20f alternate bars have the tooth parts disposed in opposition.

The bars are obtained starting from straight portions of steel bars which are bent in a mould and then ground on the surface of the cutting edge. Grinding or sharpening of the cutting edge can be performed each time it is necessary.

1. A shredding apparatus with rotary blades, comprising a plurality of shredding rollers (14, 15, 16) with parallel axes, each roller comprising a rotationally driven shaft and a plurality of rotating blades spaced axially therealong, and a cut cooperating and screening member (20), the blades of adjacent rollers being intercalated axially, characterized in that the cut-cooperating and screening member comprises a plurality of bars (22) having a shape among the following: a broken line (22a), a wavy line (22b), so as to have portions of bar protruding on one side and the other of a theoretical median line (m) of the bar.

2. An apparatus according to claim 1 characterized in that the bars are disposed with the respective median lines substantially parallel to the axis of the rollers and having a cutting edge (24, 25) in the part thereof facing toward the axis of the rollers.

3. An apparatus according to claim 1, characterized in that adjacent bars of the member (20a, 20d) are disposed with the respective protruding parts aligned in a direction at right angles to the extension of the bars.

4. An apparatus according to claim 1, characterized in that adjacent bars of the member (20b, 20e) are disposed with respective protruding parts offset from one another.

5. An apparatus according to claim 1, characterized in that adjacent bars of the member (20c, 20f) have opposing protruding parts.

6. An apparatus according to claim 1 wherein the bars are obtained by bending a steel bar in a mould and grinding the surface thereof intended to face toward the axis of the roller.

7. A cut-cooperating and screening member for a shredding apparatus with rotary blades characterized in that it comprises a plurality of bars (22) having a shape among the following: a broken line, a curved or wavy line, so as to have portions of bar protruding on one side and the other of a theoretical median line (m) of the bar.
